(19) United States
(12) Patent Application Publication
(10) Pub. No.: US 2024/0163383 A1
(43) Pub. Date: May 16, 2024

(54) INFORMATION PROCESSING APPARATUS AND METHOD FOR CONTROLLING AN INFORMATION PROCESSING APPARATUS

(71) Applicant: CANON KABUSHIKI KAISHA, Tokyo (JP)

(72) Inventor: YUKI KANAGAWA, Chiba (JP)

(21) Appl. No.: 18/507,173

(22) Filed: Nov. 13, 2023

(30) Foreign Application Priority Data
Nov. 16, 2022 (JP) 2022-183415

(51) Int. Cl. H04N 1/00

(52) U.S. Cl. CPC H04N 1/00517; H04N 1/00427

(57) ABSTRACT

An information processing apparatus switches and displays, on a display unit, a first screen displaying a display component indicating each function of a first function group having a relatively high order among functions included in an application, a second screen displaying a display component indicating each function of a second function group including the first function group and a function group having an order lower than the first function group, a first setting screen receiving a setting of a first function included in the first function group displayed on the first screen and displaying a setting having a relatively high order in the first function, and a second setting screen receiving a setting of the first function included in the second function group displayed on the second screen and displaying more settings of the first function than the setting of the first function displayed on the first setting screen.

### BACKGROUND OF THE INVENTION

### Field of the Invention

The present disclosure relates to an information processing apparatus and a method for controlling an information processing apparatus.

### Description of the Related Art

In information processing apparatuses, various applications are used. Image processing apparatuses such as multifunction apparatuses are also equipped with various applications, and the user can activate the applications on an operation panel.

Japanese Patent Laid-Open No. 2010-147998 discloses an image processing apparatus in which an application can be switched between a simple display mode which displays only items having high frequencies of use and a normal display mode which displays all the items.

There is a demand for a further improvement of convenience for users who use applications.

### SUMMARY OF THE INVENTION

An information processing apparatus according to an aspect of the present disclosure includes: a display control unit configured to be capable of switching and displaying, on a display unit, a first screen configured to display a display component indicating each function of a first function group having a relatively high order among functions included in an application, a second screen configured to be displayed on the basis of an instruction of a user to the first screen and to display a display component indicating each function of a second function group including the first function group and a function group having an order lower than the first function group, a first setting screen configured to be capable of receiving a setting of a first function included in the first function group displayed on the first screen and to display a setting having a relatively high order in the first function, and a second setting screen configured to be capable of receiving a setting of the first function included in the second function group displayed on the second screen and to display more settings of the first function than the setting of the first function displayed on the first setting screen.

Further features of the present invention will become apparent from the following description of exemplary embodiments with reference to the attached drawings.

### BRIEF DESCRIPTION OF THE DRAWINGS

FIG. 1 is a schematic diagram showing a configuration of a system;

FIG. 2 is a block diagram showing an example of a hardware configuration of an image processing apparatus;

FIG. 3 is a block diagram showing an example of a software configuration of the image processing apparatus;

FIG. 4 is a diagram describing screen transition;

FIG. 5 is a diagram showing a table indicating items settable depending on the type of screen;

FIG. 6 is a flowchart showing screen display processing;

FIG. 7 is a flowchart showing detailed processing of function button display processing;

FIG. 8 is a diagram describing screen transition between screens;

FIG. 9 is a flowchart showing detailed processing of function button display processing; and

FIG. 10 is a diagram showing a main menu screen.

### DESCRIPTION OF THE EMBODIMENTS

Hereinafter, preferred embodiments of the present disclosure will be described in detail by referring to attached drawings. Note that the following embodiments are not intended to limit the matters of the present disclosure, and all combinations of features described in the following embodiments are not necessarily essential for the solution of the present disclosure. Note that the same configurations are denoted with the same reference signs for description.

### First Embodiment

In the present embodiment, an embodiment using a Multi Function Peripheral (MFP) equipped with a plurality of functions such as a printing function, a scanning function, and a transmitting function will be described. An MFP is an image processing apparatus which conducts image processing. In addition, an MFP is an information processing apparatus which conducts various information processing.

An image processing apparatus has an operation panel on the main body, and is configured such that the user can select items displayed on the operation panel to achieve various functions or conduct various settings. An image processing apparatus is equipped with a wide variety of functions (also referred to as main functions). In addition, each main function further contains various setting items (referred to as sub-functions). A copy function will be described as an example of main functions. The copy function, which is a main function, contains, as sub-functions, a color function containing setting values such as monochrome copy or color copy, a scaling function containing setting values such as same-size printing or reduced printing, and the like. These sub-functions (setting items) include “functions having high frequencies of use” and “functions having low frequencies of use”. If a setting screen corresponding to all functions is displayed in an image processing apparatus, a setting screen containing many various functions is displayed, which increases the difficulty in setting operations for users who are not accustomed to the setting.

Since there are functions having high frequencies of use and functions having low frequencies of use as described above, there is a demand for improvement in the convenience for users to operate the setting. For example, there is a method in which an “application (simple app) in which only functions having high frequencies of use are gathered” is provided to reduce the number of setting items which can be set by users and to simplify the screen, thus reducing the difficulty in setting. Then, in addition to the simple app, an “application (full-function app) in which all functions can be set” is also provided for users who want to use functions having low frequencies of use as well. This allows users to use the applications separately depending on the situation, thus making it possible to improve the convenience for users at least.

However, in the above-described method, there is a case where a user cannot know which is a suitable application for the user, the simple app or the full-function app. In particular, a user who does not know functions well already needs to separately use the applications depending on the purpose, which imposes a burden on the user in some cases at the time of selecting an application. Here, the switching of applications has been described as an example, a similar problem occurs in the case of switching modes in one application.

In view of this, in the present embodiment, an example will be described in which an efficient operability that does not make it difficult for a user to decide the operation is achieved and the convenience for users is improved. Specifically, an image processing apparatus is configured to display setting values having high frequencies of use of a function having a high frequency of use in a shallow layer in one application. On the other hand, the image processing apparatus is configured to display all the setting values including a setting value which does not have a high frequency of use in a deep layer. This makes it possible to achieve an efficient operability that does not make it difficult for a user to decide the operation. Hereinafter, a specific example will be described.

### <System Configuration>

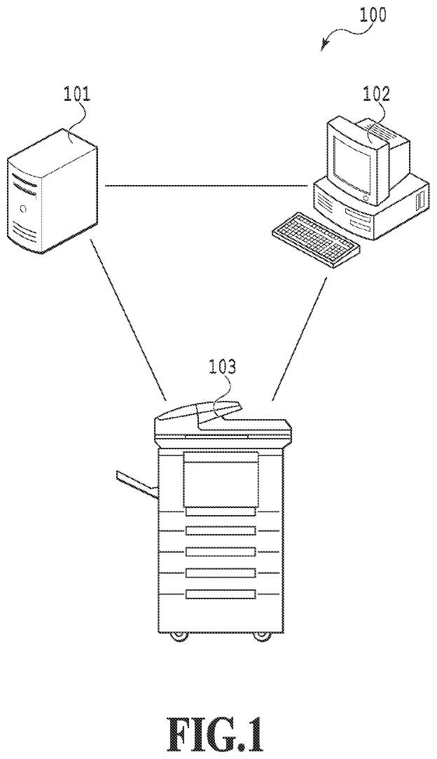

FIG. 1 is a schematic diagram showing a configuration of a system 100 including an image processing apparatus in the present embodiment. The system 100 includes an image processing apparatus 103 as an information processing apparatus, a server 101, and a client PC (personal computer) 102 which are connected on a network.

The image processing apparatus 103 is an MFP. The image processing apparatus 103 has a function of copying a paper original and a function of printing print data sent from an external printer driver. In addition, the image processing apparatus 103 has a function of scanning a paper original and transmitting the image data to an external file server (server 101) or a mail address (SEND function, SCAN AND TRANSMIT function). In addition, the image processing apparatus 103 has a function of transmitting data to another image processing apparatus and printing the data in the image processing apparatus of the transmission destination (remote copy function, facsimile function). The image processing apparatus 103 may have various other functions. Note that the above-mentioned functions are merely examples, and functions are not limited to these examples. The image processing apparatus 103 may be an apparatus having a single function. The printing system of the image processing apparatus 103 used in the present embodiment may be an electrophotographic system or an inkjet system, or may be another system.

Although it is supposed that the image processing apparatus 103 is connected with the server 101 and the client PC 102 through, for example, Ethernet (registered trademark), but it is not limited to this example. In addition, the case where there are a plurality of apparatuses is described as an example, but, for example, both the server 101 and the client PC 102 may be configured with the same computer. The server 101 and the client PC 102 may be incorporated in the image processing apparatus 103, so that the system 100 is configured with the single image processing apparatus 103. Note that although in the present embodiment, the image processing apparatus 103 is presented as an example of the information processing apparatus, the information processing apparatus is not limited to the image processing apparatus 103 and may be a PC, a terminal apparatus, or a smartphone.

### <Hardware Configuration of Image Processing Apparatus>

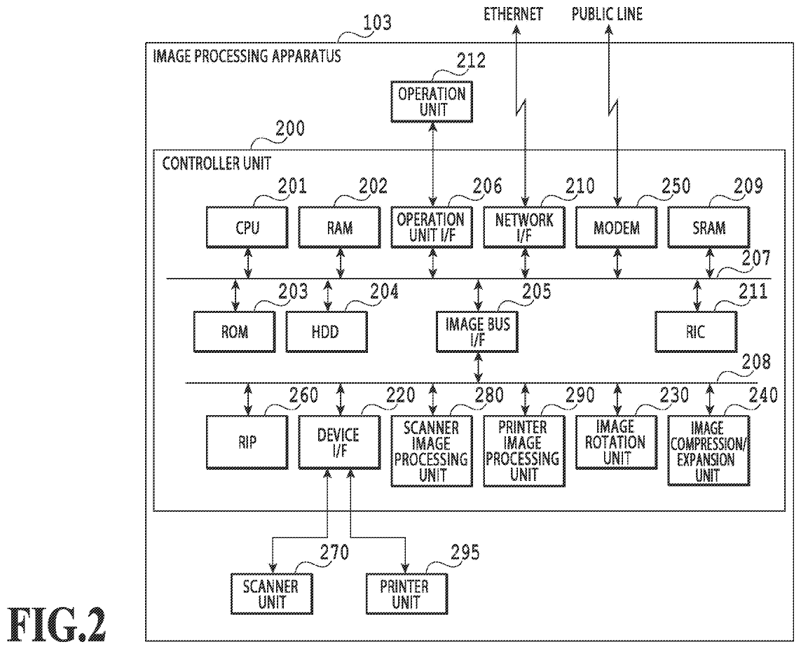

FIG. 2 is a block diagram showing an example of a hardware configuration of the image processing apparatus 103 in the present embodiment. The image processing apparatus 103 includes a controller unit 200, an operation unit 212, a scanner unit 270, and a printer unit 295. The controller unit 200 includes a CPU 201, a RAM 202, a ROM 203, a HDD 204, an Image Bus I/F 205, an operation unit I/F 206, an SRAM 209, a Network I/F 210, an RTC 211, and a MODEM 250. In addition, the controller unit 200 includes a device I/F 220, an image rotation unit 230, an image compression/expansion unit 240, a MODEM 250, a RIP 260, a scanner image processing unit 280, and a printer image processing unit 290.

The controller unit 200 is connected with the scanner unit 270 which is an image input device and the printer unit 295 which is an image output device. In addition, the controller unit 200 is connected with Ethernet (registered trademark) or a public line to input and output image information and device information. The CPU 201 is a controller which controls the image processing apparatus 103. The RAM 202 is a system work memory with which the CPU 201 operates and also an image memory in which image data is temporarily stored. The ROM 203 is a boot ROM in which a boot program of the system is stored. The HDD 204 is a hard disk drive in which system software, applications, and image data are stored.

The operation unit I/F 206 is an interface unit with the operation unit 212 including a touch panel, and outputs, to the operation unit 212, image data to be displayed on the operation unit 212. In addition, the operation unit I/F 206 plays a roll of transmitting, to the CPU 201, information which the user has inputted through the operation unit 212. The operation unit 212 is also a display unit including the touch panel. The operation unit 212 may include a hard key or the like separately and may be configured to receive inputs through the hard key. The Network I/F 210 is connected to the network and inputs and outputs information. The MODEM 250 is connected to the public line and inputs and outputs information.

The SRAM 209 is non-volatile recording medium capable of operating at high speed. The RTC 211 is a real-time clock and conducts processing of continuously counting the current time even in a state where the controller unit 200 is not on. The devices described above are arranged on a system bus 207.

The Image Bus OF 205 is a bus bridge which connects the system bus 207 and an image bus 208, which transfers image data at high speed, and converts a data structure. The image bus 208 is configured with a PCI bus or IEEE 1394. The following devices are arranged on the image bus 208. The RIP 260 is a raster image processor and rasterizes a PDL code into a bitmap image. The device OF 220 connects the scanner unit 270 and the printer unit 295, which are image input and output devices, to the controller unit 200 and conducts synchronous/asynchronous conversion of image data. The scanner image processing unit 280 corrects, processes, and edits input image data. The printer image processing unit 290 conducts correction, resolution conversion, and the like on print output image data. The image rotation unit 230 rotates image data. The image compression/expansion unit 240 conducts compression and decompression processing on image data.

### <Software Configuration of Image Processing Apparatus>

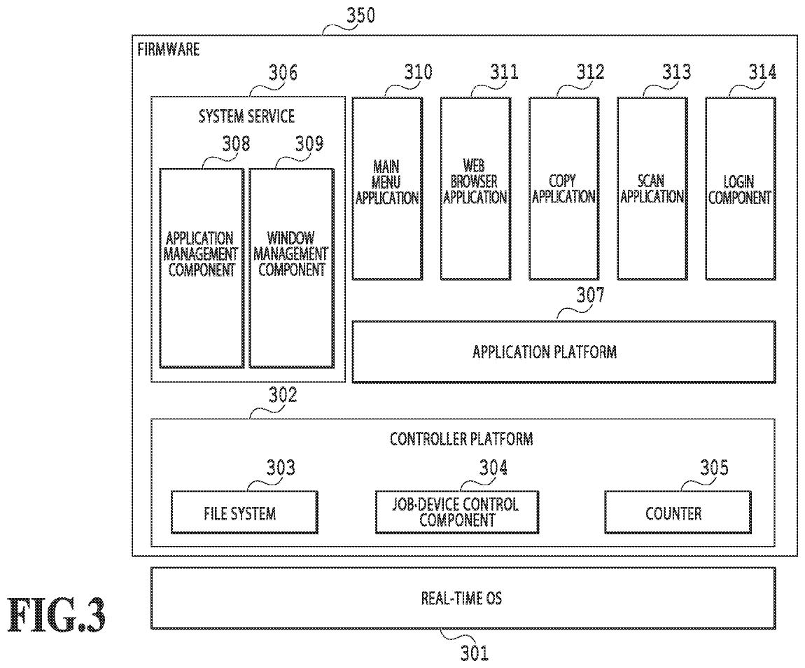

FIG. 3 is a block diagram showing an example of a software configuration of the image processing apparatus 103 in the present embodiment. The major software configuration shown in FIG. 3 is stored as so-called firmware 350 in the HDD 204 of the image processing apparatus 103, and is read to the RAM 202 and executed by the CPU 201.

The image processing apparatus 103 includes a real-time OS 301 and the firmware 350. The firmware 350 includes a controller platform 302, a system service 306, and an application platform 307. The controller platform 302 includes a file system 303, a job-device control component 304, and a counter 305. The system service 306 includes an application management component 308 and a window management component 309. The firmware 350 includes a main menu application 310, a web browser application 311, a copy application 312, a scan application 313, and a login component 314 on the application platform 307.

The real-time OS 301 is a real-time operating system and provides various resource management services and frameworks optimized to control an embedded system to software operating thereon. The various resource management services and frameworks provided by the real-time OS include multitask (thread) management of substantially operating a plurality of processes in parallel by managing a plurality of execution contexts of processing by the CPU 201. In addition, the various resource management services and frameworks include inter-task communications for implementing synchronization and data exchange between tasks. Moreover, the various resource management services and frameworks also include memory management, interrupt management, various device drivers, and protocol stacks implementing various protocol processes for a local interface, network, communications, and the like.

The file system 303 is a mechanism for storing data constructed in a storage device such as the HDD 204 or the RAM 202. The job-device control component 304 controls the hardware of the image processing apparatus 103 and controls jobs using basic functions (print, scan, communications, image conversion, and the like) provided mainly by the hardware of the image processing apparatus 103. The counter 305 manages the expiration date of each application as well as counter values of print and scan, which are stored in the SRAM 209.

The application management component 308 is a management module for installing, uninstalling, activating, stopping the applications 310, 311, 312, and 313, and the login component 314, and the like. The window management component 309 is a management module for controlling display orders of application windows included in the applications 310, 311, 312, and 313, and the login component 314, and the like.

The application platform 307 is middleware for allowing the mechanisms of the real-time OS 301 and the controller platform 302 to be used from the applications 310, 311, 312, and 313, and the login component 314, and the like.

The applications 310, 311, 312, and 313 are applied software which achieves various business models by using functions provided by the application platform 307. The main menu application 310 includes a menu function of allowing the user to select an application. The web browser application 311 includes a web browser function of allowing the user to browse a web server. The copy application 312 includes a copy function of allowing the user to copy a paper original. The scan application 313 includes a scan function of allowing the user to transmit data. Upon receipt of login notification from the login component 314, these applications conduct screen generation processing corresponding to the login user based on information of the login notification. As an example, the processing in the case where the login user is prohibited from using a web browser and prohibited from making color copy, so that the functions are limited will be given. In this case, the main menu application 310 conducts such processing that prevents the login user from selecting the web browser which the login user is prohibited from using. The copy application 312 conducts such processing that prevents the login user from selecting a color copy button.

The login component 314 is authentication software for conducting user authentication. The login component 314 conducts login processing based on a user name and a password inputted in the operation unit 212. In the case where the authentication has been failed, the login component 314 conducts error display. In the case where the authentication has been successful, the login component 314 conducts a series of processing following the authentication.

### <Display Control of Screens>

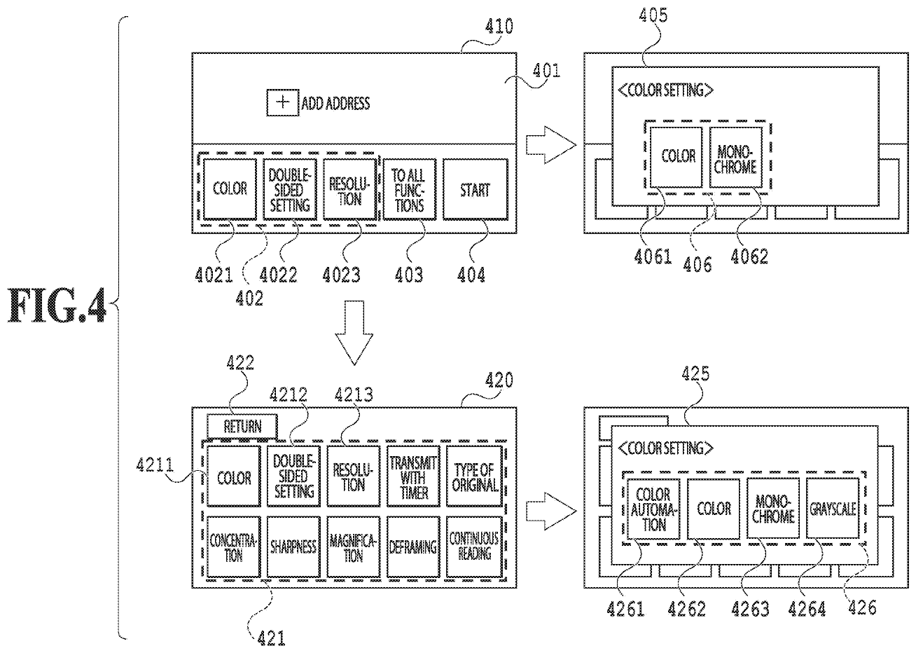

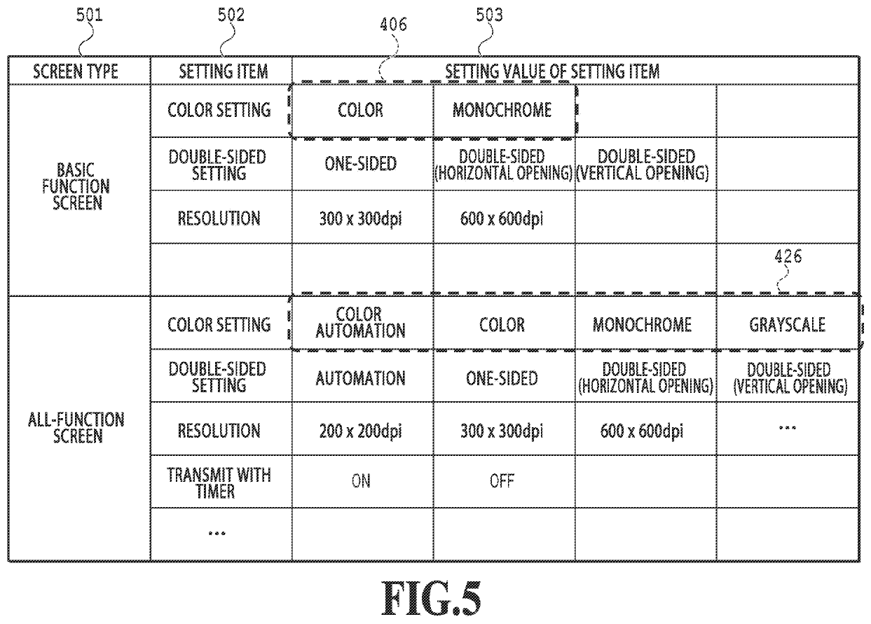

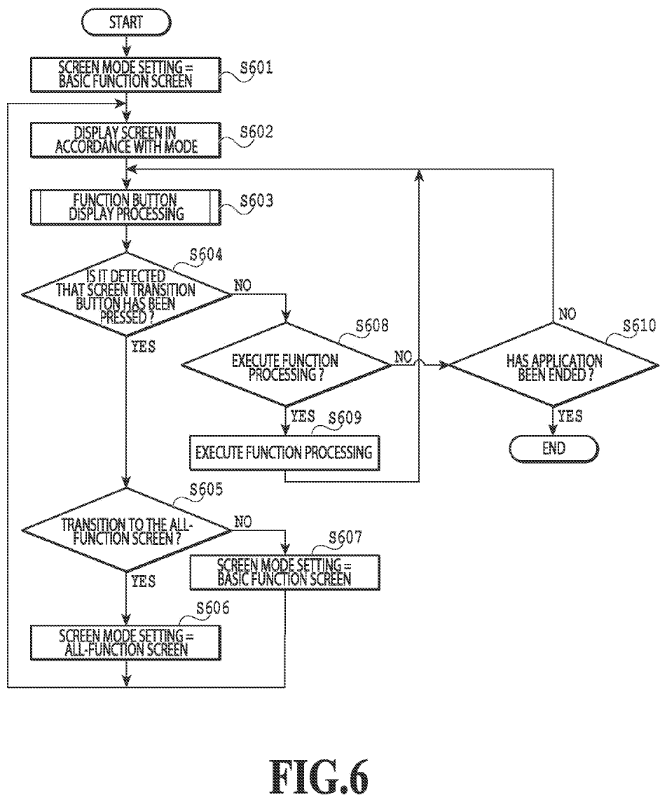

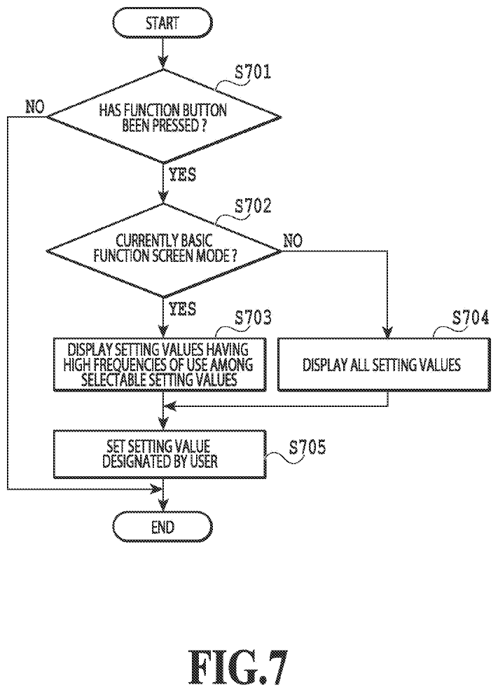

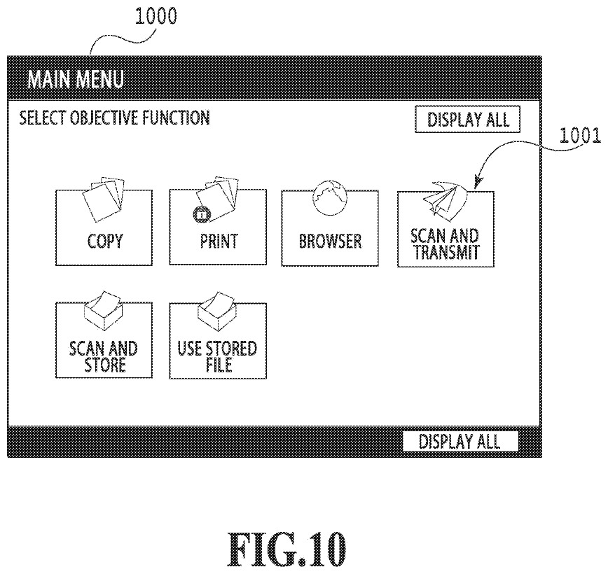

Next, a display control of screens in the image processing apparatus 103 in the present embodiment will be described with reference to FIG. 4, FIG. 5, FIG. 6, FIG. 7, and FIG. 10.

FIG. 4 is a diagram describing screen transition of screens including a basic function screen 410 and an all-function screen 420 in the present embodiment. Each screen described in the present embodiment is displayed on the operation unit 212 by output of the window management component 309 to the operation unit 212. FIG. 10 is a diagram showing a main menu screen. The main menu screen 1000 is a screen displayed on the operation unit 212 by the main menu application 310 cooperating with the window management component 309. The main menu screen 1000 displays a plurality of menu items. The present embodiment is configured such that an application corresponding to each menu item is activated in accordance with selection of the menu item by the user. FIG. 4 shows an example in which the user selected SCAN AND TRANSMIT 1001 from among the plurality of menu items shown in FIG. 10. This activates the scan application 313, and the scan application 313 cooperates with the window management component 309 to display the basic function screen 410 shown in FIG. 4 on the operation unit 212.

The window management component 309 and the scan application 313 are stored as the firmware 350 in the HDD 204 of the image processing apparatus 103, and is read to the RAM 202 and executed by the CPU 201.

Hereinafter, the basic function screen 410 and the all-function screen 420 are described by using FIG. 4. In the example of FIG. 4, a screen corresponding to the scan application 313 is displayed on the basic function screen 410. The content to be displayed on the basic function screen 410 is different depending on the activated application. The basic function screen 410 is a screen initially displayed by an application in the case where the application is activated. More specifically, the basic function screen 410 can also be said to be the first screen that is capable of receiving operation by the user after the application is activated. For example, although a screen showing a logo or Booting Up can be initially displayed upon activation of an application, such a screen is not supposed to be included in the basic function screen.

The “SCAN AND TRANSMIT” provided by the scan application 313 is a function (main function) enabling the user to scan and convert the result of the scan into an electronic file and transmit the electronic file. The basic function screen 410 contains a button 401 to add an address. In addition, a first function group 402 composed of one or more functions each having a relatively high frequency of use than the other functions among the functions (setting items) contained in the scan application 313 is arranged in the basic function screen 410. The first function group contains COLOR 4021 which is a function (setting items) of setting a setting value of color; DOUBLE-SIDED PRINTING 4022 which is a function (setting items) of setting a setting value of double-sided printing, and RESOLUTION 4023 which is a function (setting items) of setting a setting value of resolution. That is, COLOR 4021, DOUBLE-SIDED PRINTING 4022, and RESOLUTION 4023 are functions having relatively higher frequencies of use than the other functions in the scan application 313. Note that the frequency of use may be a frequency of use of a user notified of by the login component 314 or a frequency of use of all users using the image processing apparatus 103. Alternatively, the frequency of use may be a frequency of use obtained by referring to information from the outside.

In the basic function screen 410, a start button 404 for executing the main function of the scan application 313 is disposed. When the user selects the start button 404, the scan application 313 executes the function “SCAN AND TRANSMIT”, which is a main function, in accordance with the set various setting values.

In the basic function screen 410, a transition button 403 for transitioning from the basic function screen 410 to the all-function screen 420 is disposed. The transition button 403 reads “TO ALL FUNCTIONS”. When the user selects the transition button 403 in the basic function screen 410, the scan application 313 displays the all-function screen 420 on the operation unit 212.

In the all-function screen 420, a second function group 421 composed of all the functions included in the scan application 313 is disposed. The second function group 421 includes the first function group. That is, COLOR 4211, DOUBLE-SIDED SETTING 4212, and RESOLUTION 4213 in the all-function screen 420 are in the first function group in the basic function screen 410. In the example of FIG. 4, the first function group in the all-function screen 420 is displayed in the same configurations (the same size and the same display name). Note that it is only necessary that the user can identify the first function group in the all-function screen 420, and the first function group does not necessarily have to be displayed in the same configuration as in the first function group in the basic function screen 410. In addition, although the example of FIG. 4 shows the same order of arrangement of the first function group in the all-function screen 420 as the arrangement of the first function group 402 in the basic function screen 410, the order of arrangement is not limited to this. The order of arrangement of the first function group in the all-function screen 420 may be the same as or different from the arrangement of the first function group 402 in the basic function screen 410. In addition, in a case where the number of functions of the second function group 421 is too many to display all the functions on the operation unit 212, a scroll bar, a page switching button, or the like, which is not shown, may be disposed.

In the all-function screen 420, a return button 422 for transitioning (returning) to the basic function screen 410 is disposed besides the second function group 421. When the user selects the return button 422, the scan application 313 transitions from the all-function screen 420 to the basic function screen 410.

Next, a screen control in the case where a function included in the first function group 402 in the basic function screen 410 is selected by the user will be described. In the example of FIG. 4, it is assumed that COLOR 4021 in the first function group 402 is selected by the user. Then, the scan application 313 displays a color setting screen 405 on the operation unit 212. The color setting screen 405 contains setting values 406. Specifically, the color setting screen 405 contains two setting values, that is, COLOR 4061 and MONOCHROME 4062. In the case where COLOR 4061 is selected by the user, the scan application 313 conducts setting for scanning and obtaining a color image. In the case where MONOCHROME 4062 is selected by the user, the scan application 313 conducts setting for scanning and obtaining a monochrome image. Here, in the color setting screen 405 displayed through COLOR 4021 of the basic function screen 410, the setting values 406 which have relatively high frequencies of use than the other setting values among the setting values which the scan application 313 can set in color setting are displayed. That is, in the basic function screen 410, functions having relatively high frequencies of use than the other functions are disposed as the disposed first function group 402. Then, in the setting screen in which to set setting values upon selection of the function of the basic function screen 410, setting values having relatively high frequencies of use than the other setting values are disposed.

In the all-function screen 420 on the other hand as well, COLOR 4211 is contained in the second function group 421 as mentioned above. When COLOR 4211 in the second function group 421 is selected by the user, the scan application 313 displays a color setting screen 425 on the operation unit 212. For explanation, the color setting screen 405 is referred to as a first color setting screen 405 and the color setting screen 425 is referred to as a second color setting screen 425. The second color setting screen 425 contains all the setting values 426 regarding color. Specifically, the second color setting screen 425 contains COLOR AUTOMATION 4261, COLOR 4262, MONOCHROME 4263, and GRAYSCALE 4264. Among the setting values 426 of the second color setting screen 425, COLOR 4262 and MONOCHROME 4263 are disposed also in the first color setting screen 405, but COLOR AUTOMATION 4261 and GRAYSCALE 4264 are not disposed in the first color setting screen 405.

In this way, even in the case of setting the same function (setting item) in the scan application 313, settable setting values are differently displayed depending on whether the screen of transition source is the basic function screen 410 or the all-function screen 420. This make it possible for a user to set functions and setting values having high frequencies of use through the basic function screen 410 in a shallow layer, which is displayed after activation, thus improving operability and usability. On the other hand, a user who desires detailed functions or setting values can set the detailed functions or setting values through the all-function screen 420 in the deep layer.

FIG. 5 is a diagram showing a table indicating items settable depending on the type of screen in the present embodiment. The table shown in FIG. 5 is stored, for example, in the HDD 204 or the like. FIG. 5 corresponds to the configuration described in terms of the screen transition of FIG. 4. FIG. 5 includes BASIC FUNCTION SCREEN and ALL-FUNCTION SCREEN as SCREEN TYPE 501. In SETTING ITEM 502, setting items (functions) which can be set in each of BASIC FUNCTION SCREEN and ALL-FUNCTION SCREEN are defined. The scan application 313 refers to the table shown in FIG. 5 to determine setting items (functions) to be displayed in each of the basic function screen 410 and the all-function screen 420. SETTING VALUE OF SETTING ITEM 503 show setting values to be disposed (displayed) in the setting screen displayed in the case where each of the setting items is selected. In FIG. 5, setting values 406 are setting values disposed in the first setting screen, which is displayed in the case where COLOR 4021 is selected in the basic function screen 410, and correspond to the example shown in FIG. 4. In FIG. 5, setting values 426 are setting values disposed in the second setting screen, which is displayed in the case where COLOR 4211 is selected in the all-function screen 420, and correspond to the example shown in FIG. 4.

Although the case of color setting is described as an example in FIG. 4, relations similar to the examples described with the color setting are also specified also in setting items other than the color setting as shown in FIG. 5. That is, the basic function screen 410 is configured such that the first function group (setting item group) having relatively high frequencies of use is displayed. Then, in the case where a function in the first function group is selected, setting values having relatively high frequencies of use are displayed in the setting screen. On the other hand, the all-function screen 420 is configured such that the second function group containing all the functions is displayed. Then, in the case where a function in the second function group is selected, all the settable setting values are displayed in the setting screen.

### <Flowchart>

FIG. 6 is a flowchart showing screen display processing in the present embodiment. The processing shown in FIG. 6 is achieved by the firmware 350 stored in the HDD 204 of the image processing apparatus 103 being read to the RAM 202 and executed by the CPU 201. More specifically, the processing is such that the scan application 313 contained in the firmware 350 is read to the RAM 202 and executed by the CPU 201. As mentioned above, the scan application 313 is configured to conduct the display control in cooperation with the window management component 309. Note that the sign “S” in the explanation of each processing means a step in the flowchart. The processing in FIG. 6 is processing executed in the case where SCAN AND TRANSMIT 1001 is selected by the user in the main menu screen 1000 shown in FIG. 10 and the scan application 313 is activated. Note that the processing of FIG. 6 may be executed in the case where the scan application 313 is restarted from a standby state.

In S601, the scan application 313 conducts initial setting of setting the screen mode setting to the basic function screen mode. Subsequently, in S602, the scan application 313 displays a screen in accordance with the screen mode on the operation unit 212 in cooperation with the window management component 309. In S602, in the case where the screen mode is the basic function screen mode, the basic function screen 410 is displayed on the operation unit 212. On the other hand, in the case where the screen mode is the all-function screen mode, the all-function screen 420 is displayed on the operation unit 212.

Subsequently, in S603, the scan application 313 conducts function button display processing in accordance with the screen mode in cooperation with the window management component 309. The detail of S603 will be described later by using FIG. 7. After S603, in S604, the scan application 313 determines whether the screen transition button has been pressed (touched) by the user. The screen transition button is the transition button 403 and the return button 422 in the example of FIG. 4. If it is determined that the screen transition button has been pressed, the scan application 313 proceeds to S605. If it is determined that the screen transition button has not been pressed, the scan application 313 proceeds to S608.

In S605, the scan application 313 determines whether to transition to the all-function screen. If the transition button 403 has been pressed, the scan application 313 determines to transition to the all-function screen. If the return button 422 has been pressed, the scan application 313 determines not to transition to the all-function screen. That is, if the return button 422 has been pressed, the scan application 313 determines to transition to the basic function screen. If it is determined to transition to the all-function screen, the scan application 313 sets the screen mode setting to the all-function screen in S606, and proceeds to S602. If it is determined not to transition to the all-function screen, the scan application 313 sets the screen mode setting to the basic function screen in S607, and proceeds to S602. Then, in S602, the scan application 313 continues displaying a screen corresponding to the mode, and continuously conducts the processing following S603.

In S608, the scan application 313 determines whether to execute function processing. For example, in the example of FIG. 4, the scan application 313 determines whether the start button 404 has been pressed. If it is determined to execute the function processing, the scan application 313 executes the function processing in S609. After S609, the scan application 313 proceeds to S603. Then, the scan application 313 continuously conducts the processing following S603. If it is determined not to execute the function processing in S608, the scan application 313 determines whether the application has been ended in S610. For example, if another menu screen is displayed or the image processing apparatus is turned into the standby state, the scan application 313 determines that the application has been ended, and ends the processing of the flowchart of FIG. 6. If it is determined that the application has not been ended, the scan application 313 proceeds to S603, and continuously conducts the processing following S603.

FIG. 7 is a flowchart showing detailed processing of the function button display processing in S603 of FIG. 6. In S701, the scan application 313 determines whether the function button has been pressed. For example, in the case where the basic function screen 410 of FIG. 4 is displayed, the scan application 313 determines whether the button of each function of the first function group 402 has been pressed. In the case where the all-function screen 420 of FIG. 4 is displayed, the scan application 313 determines whether the button of each function of the second function group 421 has been pressed. If it is determined that the function button has not been pressed, the scan application 313 ends the processing of the flowchart shown in FIG. 7. If it is determined that the function button has been pressed, the scan application 313 proceeds to S702.

In S702, the scan application 313 determines whether the current screen mode is the basic function screen mode. If it is determined that the current screen mode is the basic function screen mode, the scan application 313 proceeds to S703. In S703, the scan application 313 displays setting values having relatively high frequencies of use among the selectable setting values. That is, the scan application 313 displays only some setting values having high frequencies of use among all the selectable setting values. After S703, the scan application 313 proceeds to S705. On the other hand, if it is determined that the current screen mode is not the basic function screen mode, the scan application 313 proceeds to S704. In S704, the scan application 313 displays all the selectable setting values. After S704, the scan application 313 proceeds to S705.

In S705, the scan application 313 sets a setting value designated by the user. Then, the scan application 313 ends the processing of the flowchart shown in FIG. 7.

According to the present embodiment as described above, it is possible to achieve an efficient operability that does not make it difficult for a user to decide the operation and thus improve the convenience for users. That is, as described in the above mentioned example, the image processing apparatus is configured to display setting values having high frequencies of use of a function having a high frequency of use on the setting screen to which the first screen, which is displayed immediately after the activation (that is, a screen in a shallow layer), transitions, in one application. Hence, in most utilization forms, this makes it possible for the user to complete the setting operation only on the screen in the shallow layer, and to improve the convenience. In addition, since displaying too many items is suppressed, an efficient operability that does not make it difficult for a user to decide the operation can be achieved. On the other hand, the image processing apparatus is configured to display setting values corresponding to all functions on the setting screen to which the second screen, to which the first screen transitions (that is, a screen in a deep layer), transitions. This makes it possible for the user to complete the setting operation for a function and setting values having low frequencies of use in one application as well.

### Second Embodiment

In the first embodiment, an example in which only setting values having relatively high frequencies of use are displayed in the setting screen in the case where a function is selected from the basic function screen has been described. In the present embodiment, an example provided with a transition button for displaying all setting values of a function in addition to setting values having relatively high frequencies of use in a setting screen in the case where a function is selected from the basic function screen will be described. Note that since the basic configuration is the same as in the example described in the first embodiment, only different points will be mainly explained below.

### <Display Control of Screens>

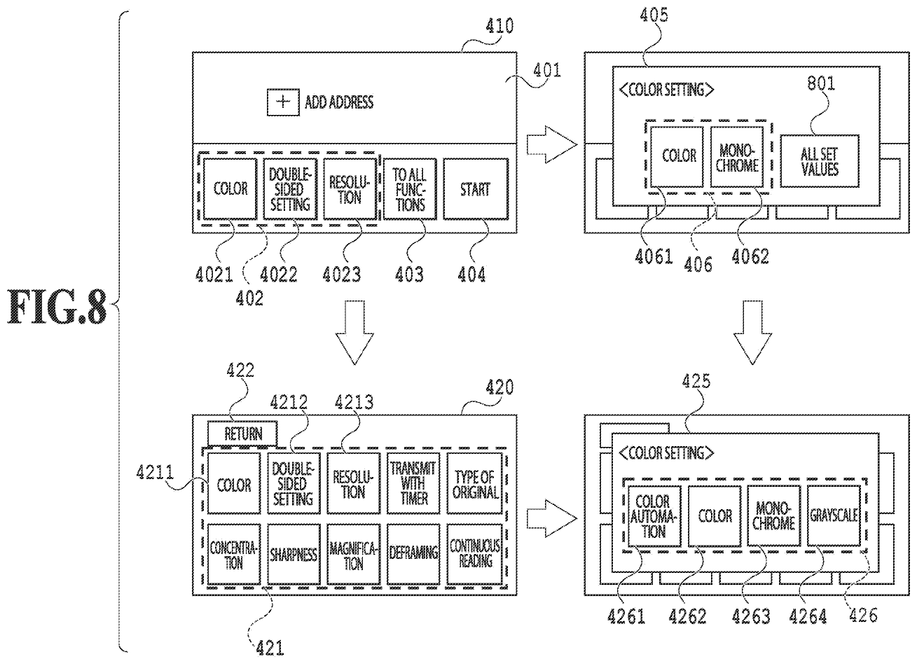

FIG. 8 is a diagram describing screen transition of screens including a basic function screen 410 and an all-function screen 420 in the present embodiment. The basic configuration is the same as in the example described in terms of FIG. 4. In the first embodiment, an example in which setting values having relatively high frequencies of use are displayed in the first color setting screen 405 to which the basic function screen 410 transitions has been described. In the present embodiment, as shown in FIG. 8, the first color setting screen 405 is provided with a transition button 801 for transitioning to a screen which displays all setting values. If the transition button 801 is pressed by a user, a second color setting screen 425 which displays all setting values is displayed as in the case where the COLOR 4211 is pressed by a user in the all-function screen 420.

### <Flowchart>

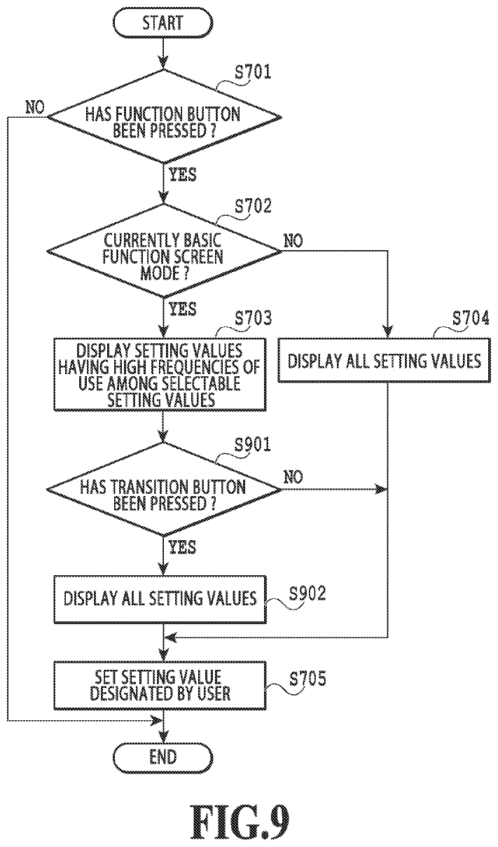

FIG. 9 is a flowchart showing detailed processing of the function button display processing in S603 of FIG. 6, like FIG. 7. FIG. 9 is the same as the flowchart of FIG. 7 except that processing of S901 and S902 are added between S703 and S705.

Following the processing of S703, the scan application 313 determines whether the transition button has been pressed in S901. That is, the scan application 313 determines whether the transition button 801 for transitioning to a screen which displays all setting values of FIG. 8 has been pressed. If it is determined that the transition button has not been pressed, the scan application 313 proceeds to S705. If it is determined that the transition button has been pressed, the scan application 313 displays all the setting values in S902. After S902, the scan application 313 proceeds to S705.

As described above, in the present embodiment as well, it is possible to achieve an efficient operability that does not make it difficult for a user to decide the operation and thus improve the convenience for users. That is, the present embodiment makes it possible for a user to conduct setting with a small number of operations in the case where the user wants to set a setting value having a relatively low frequency of use of a function having a relatively high frequency of use. Hence, the convenience for users can be improved.

### Other Embodiments

Although “SCAN AND TRANSMIT” has been mainly described as an example in the above-mentioned embodiments, embodiments using other functions are also possible.

In addition, in the above-mentioned embodiments, the setting items in scanning have been described as an example of functions having high frequencies of use and functions having low frequencies of use. That is, an example in which a plurality of sub-functions to be set by means of the setting items are contained in the scan function, which is a main function of the image processing apparatus. Then, an example in which processing corresponding to the frequency of use of a sub-function has been described. However, the present disclosure is not limited to this example. In a multifunction apparatus having many functions like an MFP, processing corresponding to frequencies of use of its functions (that is, main functions) may be conducted. In other words, the “functions” described in the above-described embodiments may be main functions. Moreover, although the image processing apparatus having main functions and sub-functions has been described as an example in the above-mentioned embodiments, the present disclosure is not limited to this example. Any embodiment is possible as long as the embodiment is such that the processing described in the above-mentioned embodiments is conducted in accordance with a frequency of use in an information processing apparatus having a plurality of functions.

In addition, in the above-mentioned embodiments, an example in which the button icons are displayed as display components to receive an instruction from the user has been described. That is, an example in which an instruction of the user is received as the user presses a button icon in the case of selecting a function or selecting a setting value has been described. However, the display component is not limited to an icon. Any display components such as letters, images, or photographs may be used.

In addition. in the above-mentioned embodiments, an example in which the image processing apparatus is configured to display the setting values corresponding to all the functions on the setting screen to which the all-function screen transitions has been described. However, the present disclosure is not limited to this example, and the setting screen to which the all-function screen transitions only has to be configured to display more setting values than the setting screen to which the basic function screen transitions. For example, there is also a case where all the setting values cannot be displayed on a screen of the operation unit 212. Hence, the setting screen to which the all-function screen transitions, at least, has to be configured to display more setting values than the setting screen to which the basic function screen transitions.

In addition, in the above-mentioned embodiments, since various settings are managed as numerical values on data, the various settings have been described as “setting values”. However, the various settings only have to be capable of specifying settings of a function, and do not necessarily have to be managed as setting values.

In addition, the above-mentioned embodiments have been described by giving functions having relatively high frequencies of use and functions having relatively low frequencies of use as well as setting values having relatively high frequencies of use and setting values having relatively low frequencies of use as an example. However, the present disclosure does not necessarily have to depend on the frequencies of use. The processing of the above-mentioned embodiments may be conducted by giving predetermined ordering to functions and setting values and by using functions (setting values) having relatively high orders or functions (or setting values) having relatively low orders. The frequency of use is an example of the predetermined ordering. That is, a relatively high frequency of use indicates that the order of frequency of use is relatively high. As another example of the frequency of use, for example, priorities that a manager side wants users to use may be used as the predetermined ordering. Alternatively, probabilities that users may use items may be used as the predetermined ordering. In these cases as well, the convenience for users can be improved as in the case of the above-mentioned embodiments. Note that a relatively high order indicates that the order is higher than a predetermined threshold provided.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-183415, filed Nov. 16, 2022, which is hereby incorporated by reference wherein in its entirety.

What is claimed is:

1. An information processing apparatus comprising:
a display control unit configured to be capable of switching and displaying, on a display unit,
a first screen configured to display a display component indicating each function of a first function group having a relatively high order among functions included in an application,
a second screen configured to be displayed on the basis of an instruction of a user to the first screen and to display a display component indicating each function of a second function group including the first function group and a function group having an order lower than the first function group,
a first setting screen configured to be capable of receiving a setting of a first function included in the first function group displayed on the first screen and to display a setting having a relatively high order in the first function, and
a second setting screen configured to be capable of receiving a setting of the first function included in the second function group displayed on the second screen and to display more settings of the first function than the setting of the first function displayed on the first setting screen.

2. The information processing apparatus according to claim 1, wherein
the display control unit displays, on the first screen, a display component configured to receive an instruction to transition to the second screen.

3. The information processing apparatus according to claim 1, wherein
the display control unit displays, on the second screen, a display component configured to receive an instruction to transition to the first screen.

4. The information processing apparatus according to claim 1, wherein
the display control unit displays the first setting screen on the basis of the user selecting a display component indicating the first function in the first screen.

5. The information processing apparatus according to claim 1, wherein
the display control unit displays the second setting screen on the basis of the user selecting a display component indicating the first function in the second screen.

6. The information processing apparatus according to claim 1, wherein
the display control unit displays a display component indicating the first function in the first screen and a display component indicating the first function in the second screen in a same configuration.

7. The information processing apparatus according to claim 1, wherein
the display control unit displays, on the first setting screen, a display component configured to receive an instruction to transition to the second setting screen.

8. The information processing apparatus according to claim 1, wherein
the order is an order of a frequency of use in the application.

9. The information processing apparatus according to claim 1, further comprising:
an activation unit configured to activate the application on the basis of an instruction of a user, wherein
the first screen is a screen displayed after the application is activated.

10. An information processing apparatus comprising:
a display control unit configured to be capable of switching and displaying, on a display unit,
a first screen configured to display a display component indicating each function of a first function group having a relatively high order among functions included in an application, and
a second screen configured to be displayed on the basis of an instruction of a user to the first screen and to display a display component indicating each function of a second function group including the first function group and a function group having an order lower than the first function group, wherein
a first setting screen configured to be displayed in a case where a first function included in the first function group displayed on the first screen is selected is different from a second setting screen configured to be displayed in a case where the first function included in the second function group displayed on the second screen.

11. The information processing apparatus according to claim 10, wherein
the number of selectable settings is larger in the second setting screen than in the first setting screen.

12. A method for controlling an information processing apparatus comprising:
switching and displaying, on a display unit,
a first screen configured to display a display component indicating each function of a first function group having a relatively high order among functions included in an application,
a second screen configured to be displayed on the basis of an instruction of a user to the first screen and to display a display component indicating each function of a second function group including the first function group and a function group having an order lower than the first function group,
a first setting screen configured to be capable of receiving a setting of a first function included in the first function group displayed on the first screen and to display a setting having a relatively high order in the first function, and
a second setting screen configured to be capable of receiving a setting of the first function included in the second function group displayed on the second screen and to display more settings of the first function than the setting of the first function displayed on the first setting screen.

13. The control method according to claim 12, wherein
the first setting screen and the second setting screen are different from each other.
